(19) United States
(12) Patent Application Publication
(10) Pub. No.: US 2007/0295010 A1
(43) Pub. Date: Dec. 27, 2007

(54) Method and apparatus to generate thrust by inertial mass variance

(75) Inventor: Malcolm B. Stephens, Barrie (CA)

Correspondence Address: THE WEBB LAW FIRM, P.C., 700 KOPPERS BUILDING, 436 SEVENTH AVENUE, PITTSBURGH, PA, 15219, US

(73) Assignee: Varim Technologies Inc., Barrie (CA)

(21) Appl. No.: 11/700,307

(22) Filed: Jan. 31, 2007

(30) Foreign Application Priority Data
Jun. 27, 2006 (CA) 2550904

(51) Int. Cl. F03G 7/00

(52) U.S. Cl. 60/721; 60/698; 244/62

(57) ABSTRACT

A device for producing a net force against a base comprising a mass change object, an accelerator, a power source operatively connected to the mass change object and configured to selectively apply to the mass change object (1) a mass-increasing waveform, characterized in that the time rate of change of the power of the mass-increasing waveform is positive, and (2) a mass-decreasing waveform, characterized in that the time rate of change of the power of the mass-decreasing waveform is negative; the power source being configured to apply the mass-increasing waveform to the mass change object when the acceleration of the mass change object has at least a component opposite to the net force direction, and to apply the mass-decreasing waveform to the mass change object when the acceleration of mass change object has at least a component in the net force direction; wherein the mass-increasing waveform is a different waveform, as a function of time, than the mass decreasing waveform. The mass change object comprises a mass change region configured to have time-varying power, having a non-zero time rate of change, located thereat, wherein a vacuum is located at said region.

### FIELD OF THE INVENTION

The present invention relates generally to the field of propulsion, and more particularly, to the field of reactionless thrust.

### BACKGROUND OF THE INVENTION

For several decades, it has been sought, so far unsuccessfully, to produce reactionless thrust devices. One early example of such a drive is the “Dean Drive” described in U.S. Pat. No. 2,886,976. If successfully developed, reactionless thrust devices have the potential to revolutionize space travel.

Typically, reactionless thrust devices have been comprised of various rotating wheels and weights. It has been generally understood by physicists studying such devices that, to produce net thrust, it would be necessary to vary the mass of these weights. In the 1990s, work was produced that indicated a theoretical means to induce such mass changes.

Mass change in objects has been the subject of several scholarly papers in recognized journals [Woodward, J. F. (1990), “A New Experimental Approach to Mach's Principle and Relativistic Gravitation [sic]” Found. Phys. Lett. 3, 497-506; (1992), “A Stationary Apparent Weight Shift from a Transient Machian Mass Fluctuation” Found. Phys. Lett. 5, 425-442].

These papers describe the derivation of a formula wherein the magnitude of the mass change of an object, δm, may be estimated as:

δm≈(φ/[4πGρ₀c⁴])(δP/δt)

where φ is the gravitational potential field approximately equal to c² where c is the speed of light. G is the Newtonian gravitational constant. ρ₀ is the density of the mass medium in which the energy flux occurs (e.g. the dielectric material of a capacitor, an energy storage device). δP/δt is the time rate-of-change of the power applied to the energy storage/flux medium.

The formula's developer, James F. Woodward, indicates in refereed journals that the formula is fully consistent with both the General and Special Theories of Relativity, and is at least approximately valid for all relativistic theories of gravity. One of the conceptual underpinnings of this formula is the idea put forward by Ernst Mach in the late 1800s—that objects have inertia (and inertial reaction forces) because of the presence of other matter in the universe. Einstein codified this concept as Mach's principle and this formed one of the foundations of the General Theory of Relativity. Woodward added the principle that small regions of space-time must be locally Lorentz-invariant, thus leading to the use of Special Relativity Theory. Mathematical manipulation then leads to the development of the above-noted field equation useful for calculating mass change effects.

Further publications have considered the potential for creating thrust without the expulsion of propellant mass (i.e. a reactionless drive) [Woodward, J. F. (1992), “A Stationary Apparent Weight Shift from a Transient Machian Mass Fluctuation” Found. Phys. Lett. 5, 425-442; (1994), “Mach's Principle and Impulse Engines: Toward a Viable Physics of Star Trek?” invited paper for the 1997 NASA “Breakthrough Propulsion Physics” workshop at the Lewis Research Center, 12-14 August].

Three U.S. Pat. Nos. 5,280,864, 6,098,924 and 6,347,766 have been issued with respect to techniques to implement such a drive. However, this work to date has produced only microscopic forces of short duration. Reactionless thrust devices have not achieved practical utility, but rather, have remained laboratory curiosities.

U.S. Pat. No. 5,280,864 (“Woodward I”) is the most fundamental patent and describes a method of creating transient inertial mass variations in energy storage devices such as capacitors and inductors. Woodward I describes a capacitor mounted on a piezoelectric actuator (i.e. high-frequency audio speaker element) and driven with sinusoidal waveforms at kilohertz frequencies. A thrust device, which develops a force equivalent to a fraction of a gram over a time period of about 5 seconds, is described. The frequency of the periodic motion in the Woodward I device is quite high. Thus, the mass changes would appear and disappear quickly and these momentary inertial mass changes would be extremely difficult to measure. The Woodward I device essentially amplifies the small inertial mass change effect in the capacitor by using the actuator to accelerate the capacitor in one direction when it is “light” (i.e. of lower inertial mass) and accelerate it in the other direction when it is “heavy” (i.e. of higher inertial mass). This is supposed to result in a net measurable force.

However, when NASA hired a group of researchers at the University of Washington to evaluate this device, they found an experimental error. The researchers, Cramer, Cassissi and Fey, pointed this out in a paper presented at the American Institute of Aeronautics and Astronautics (paper no. AIAA-2001-3908). The well-known formula F=ma provides a means for calculating the force F required to induce an acceleration a in a mass m. The formula may also be expressed as F=m dv/dt where acceleration a=dv/dt (i.e. time rate of change of velocity). However,—while the mass typically stays constant, it could vary. Where the mass m varies, the more complete version of the formula must be used (i.e. F=in dv/dt+v dm/dt, where dm/dt is the time rate of change of the mass of the object). Woodward did not take the term containing dm/dt into account in his calculations. It can be shown that, if it were taken into account, the forces would all cancel out when both the actuator and the capacitor were driven by synchronized sinusoidal (AC) signals, as in Woodward I.

Nevertheless, Woodward's experiments did seem to indicate a net force being generated. This was explained in U.S. Pat. No. 6,098,924 (“Woodward II”) where it is shown that the piezoelectric driving element has a capacitance of its own that affects the process. Woodward II and U.S. Pat. No. 6,347,766 (“Woodward III”) then go on to describe two primary improvements. The first is the superposition of a harmonic driving frequency (which deals with the problem highlighted by Cramer et al.) and the second is the use of resonant mechanical structures to further amplify the force.

Woodward I, II and III all describe a resonant electrical circuit. Such a circuit requires the use of a sinusoidal (AC) waveform to be effective. All of the Woodward embodiments are based on the use of such a waveform and indeed, all of the formulas disclosed by Woodward, beyond the fundamental formula shown in Woodward I,

δm≈(φ/[4πGρ₀c⁴])(δP/δt)

are based on the assumption of a sinusoidal (AC) driving signal. Woodward chose such a signal based on the assumption that it was necessary to conserve power going into a capacitor system. A resonant circuit, once established, requires only a small amount of energy to continue operation. Ongoing energy input is required only to make up for losses in the system.

An additional device is described in U.S. Patent Application Publication No. US 2006/0065789 (“Woodward IV”). The device uses a sinusoidal waveform and operates at about 50 kHz. The critical problems relating to miniscule forces and short duration remain.

The main problems with the prior art, (primarily Woodward I, II, III and IV) are fourfold. First, the forces generated in the experimental device are very small, equivalent to fractions of a gram. Specifically, Woodward used 100 watts of input power in a 10 kHz sinusoidal waveform expecting a peak transient mass change on the order of tens of milligrams. High frequencies were used specifically to obtain higher dP/dt values, yet the expected mass changes remained small.

Second, the forces are of a short duration. In Woodward's experiments, durations of about five seconds are typical. Although not explicitly stated by Woodward, it is evident that the high power necessary to produce these short-lived mass changes (on the order of 100 W) would damage the small components if applied continuously.

Third, in order to develop appreciable effects, the Woodward devices must be operated at sonic frequencies on the order of 10-20 kHz. This presents a complication. A physical force applied to one end of a structure (e.g. a beam) does not instantaneously reach the other end, but travels to the other end as a shockwave that travels at approximately the speed of sound in the material. The speed of sound in steel and aluminum is approximately 5,000 metres per second. At 20 kHz, the shockwave will travel 0.25 metres (250 mm) in one period. However, any appreciable lag will cause a phase shift in the waveform of the force as seen at the other end of the structure. To avoid this problem, it may be necessary to limit the structure size to about 10% of the wavelength. In this scenario (i.e. where a 20 kHz input is used), the structure is limited to about 25 mm, or about 1 inch. This severely limits the scalability of the device as described in the prior art, making it unlikely that such a device could be used to create forces of industrial scale.

Fourth, the device as described in Woodward II and Woodward III must be constructed with a mechanically resonant structure. Apart from the obvious difficulties imposed by such a design restriction, it appears that any useful extraction of forces from such a device would inherently dampen the necessary resonant structure.

Therefore, these prior art devices are not well-suited to generating useful quantities of reactionless thrust.

U.S. Patent Application Publication No. US 2003/0057319 (“Fitzgerald”) purports to build on the Woodward art by incorporating a mass variation device into a wheel to amplify the effect. However, Fitzgerald appears to be based on an erroneous understanding of Woodward. Fitzgerald states at paragraph [0005] that Woodward shows that “ . . . it is possible to reduce the mass of an object by rapidly changing the energy density of that object.” A close reading of Woodward shows, however, that the time-averaged mass of the object remains unchanged. In addition, Fitzgerald states at paragraph [0053] that mass reduction will be achieved with any waveform: “The waveform of the current produced by the electrical signal source could be sinusoidal or sawtooth or any other shape that causes the electrical potential difference between the upper electrode and lower electrode to rapidly vary.” Application of elementary calculus to the δm. formula cited above shows that this is untrue—all waveforms result in a mass change that averages zero over time. As can be seen from the equation δm≈(φ/[4πGρ₀c⁴])(δP/δt), the expected mass charge of the object is related both to the density ρ₀ of the dielectric, and to the time rate of change of power applied to the object. The relationship between force and energy density in the dielectric has been derived by, inter alia, Woodward. For example, on Woodward's website (http://physics.fullerton.edu/˜jimw/general/massfluc/index.htm), Woodward arrives at an equation he labels (1.4), an expression of F=ma put in the momentum form F=pv and expressed in Einsteinian 4-vector format.

F=−[(c/ρ₀)(δρ₀/δt),f]

E=mc² is then substituted adjusting for the fact that the relevant variable is density, not mass. Thus, E=mc² becomes E₀=ρ₀c² which can be rearranged to the form ρ₀=E₀/c² where E₀ represents the energy density.

Substituting, Woodward obtains the following equation which he labels (1.5):

F=−[(1/ρ₀c)(δE₀/δt), f]

In this equation, E₀ has been substituted for the ρ₀ in the time derivative and the ρ₀ has been left in the “constant” term (1/ρ₀c).

In Woodward I, Woodward chose capacitors with a lightweight, but rigid, dielectric material having a density of 3000 kg/m³. Woodward II and Woodward III taught that the capacitors must have a material core. In papers evaluating why his initial expected results were less than expected, he speculated that movement or elastic compression in the dielectric material within the casing of the capacitor might have been affecting the results. The small distances moved by the capacitor may have magnified this problem. In his published papers; Woodward stated that, in his device, the back- and forth accelerations by the piezoelectric actuator occurred within a few angstroms. Given how small this distance is, even a small amount of elasticity in the dielectric, or a small gap between the dielectric and capacitor housing, could seriously affect the transmission of forces to the casing.

Woodward's belief that a material core was necessary suggests that he understands the inertial mass change effect as taking place within the mass-material contained within the potential field that encompasses the dielectric. Not only would a material core be necessary, on this understanding, for a mass change to take place, but the material of the core would need to be suitably rigid in order to transmit any forces that arise due to acceleration, first to the housing of the capacitor, and thence to the mechanism.

### SUMMARY OF THE INVENTION

Therefore, what is desired, in one aspect, is a method and apparatus that is configured to improve the practically achievable inertial mass change, preferably to improve the effectiveness of reactionless thrust devices. In another aspect, what is desired is a method and apparatus that more effectively and efficiently applies achieved inertial mass change to produce reactionless thrust.

Therefore, in one aspect of the invention, there is provided an object for inducing an inertial mass change therein, the object comprising a mass change region configured to have time-varying power, having a non-zero time rate of change, located thereat, wherein a vacuum is located at said region. Optionally, the object comprises an electrical device; and wherein said time-varying power comprises electrical power. Optionally, the object is selected from the group comprising capacitor, inductor and transformer, and wherein said region comprises a vacuum core. Optionally, said power is magnetic in nature. Optionally, said power comprises power of electromagnetic radiation. Optionally, said object comprises a waveguide. Optionally, said power comprises microwave power.

In another aspect of the invention, there is provided a device for inducing inertial mass change in an object, the device comprising a mass change object comprising an object for inducing an inertial mass change therein, comprising a mass change region configured to have time-varying power, having a non-zero time rate of change, located thereat, wherein a vacuum is located at said region, may be included in a device for inducing inertial mass change in an object, the device further including a power source configured to produce time-varying power having a non-zero time rate of change, the source and the mass change object being configured to locate said time-varying power at the mass change region of the mass change object to change the inertial mass of the mass change object. Optionally, the device further comprises an accelerator to accelerate the mass change object while the time-varying power is located at said mass change region. Optionally, the mass change object is selected from the group comprising capacitor, inductor and transformer, and wherein said region comprises a vacuum core. Optionally, the accelerator comprises a linear accelerator for accelerating the mass change object along a linear path. Optionally, the accelerator comprises a rotary accelerator for rotary acceleration of the mass change object. Optionally, the accelerator comprises an electric motor having servo feedback capability to produce a motion, in accordance with a predetermined motion profile, for said mass change object. Optionally, the device further comprises a connector-disconnector, configured to selectively connect and disconnect the mass change object and the accelerator, such that substantially zero force is transmitted between the mass change object and the accelerator during disconnection, and said mass change object is accelerated by the accelerator during connection. Optionally, the power source comprises a generator of waveforms and an amplifier to amplify said waveforms to selected levels. Optionally, the power source comprises a source of stored waveforms, and an amplifier to amplify said waveforms to selected levels.

In another aspect of the invention, there is provided A device for producing a net force against a base, in a net force direction, the device comprising:

at least one mass change object associated with the base, the at least one mass change object being configured to undergo an inertial mass change when power having a non-zero time rate of change is applied thereto;

an accelerator, associated with the at least one mass change object, for accelerating the at least one mass change object such that the at least one mass change object exerts a force against the base;

a power source operatively connected to the at least one mass change object and configured to selectively apply to the at least one mass change object (1) a mass-increasing waveform, characterized in that the time rate of change of the power of the mass-increasing waveform is positive, and (2) a mass-decreasing waveform, characterized in that the time rate of change of the power of the mass-decreasing waveform is negative;

the power source being configured to apply the mass-increasing waveform to the each at least one mass change object when the acceleration of that mass change object has at least a component opposite to the net force direction, and to apply the mass-decreasing waveform to the each at least one mass change object when the acceleration of that mass change object has at least a component in the net force direction;

wherein the mass-increasing waveform is a different waveform, as a function of time, than the mass decreasing waveform.

Optionally, the time rate of change of the power of the mass-increasing waveform and/or the mass-decreasing waveform is generally linear as a function of time. Optionally, the time rate of change of the power of the mass-increasing waveform and/or the mass-decreasing waveform is generally constant as a function of time. Optionally, the at least one mass change object comprises an electrical device and wherein the power source comprises an electrical power source. Optionally, the at least one mass change object comprises an electrical device selected from the group of capacitor, inductor and transformer. Optionally, the mass change object comprises a capacitor, and wherein the mass-increasing waveform comprises a sawtooth voltage waveform. Optionally, the at least one mass change object comprises a capacitor, and wherein the mass-increasing waveform and the mass-decreasing waveform each comprise a voltage waveform, as a function of time, described by the formula:

V(t)=±(1/C)[C(2t₀−2V₀+2tP₀+(δP/δt)t²)]^{1/2}

wherein t is time, t₀ is an initial time, V₀ is an integration constant representing initial voltage, P₀ is an integration constant representing initial power, C is the capacitance of the capacitor, and δP/δt is the time rate of change of the power of the mass-decreasing waveform. Optionally, the accelerator comprises a reciprocating accelerator configured to accelerate the at least one mass change object along a substantially linear path, and wherein the accelerator and power source are configured such that that the at least one mass change object is substantially unaccelerated during discontinuities in or between the mass-increasing and mass decreasing waveforms. Optionally, the accelerator comprises a rotary accelerator having at least one arm carrying the at least one mass change object in a substantially circular path about a center point, and wherein the accelerator and power supply are configured to apply the mass-increasing and mass decreasing waveforms such that the average mass change over time is substantially zero. Optionally, the accelerator comprises an actuator for moving the at least one mass change object and a controller for controlling the actuator. Optionally, the power source is configured to apply said mass-increasing and mass-decreasing waveforms in an overall waveform, wherein the overall waveform is substantially free of discontinuities (1) within the mass-increasing waveforms, (2) within the mass-decreasing waveforms, and (3) between mass-increasing and mass-decreasing waveforms. Optionally, the mass decrease waveform is generally elliptical and comprises four sections, the four sections comprising:

section A, comprising the section of the mass-decrease waveform. where t is less than t₀ and V is greater than zero volts;

section B, comprising the section of the mass decrease waveform where t is greater than t₀ and V is greater than zero volts;

section C, comprising the section of the mass-decrease waveform where t is greater than t₀ and V is less than zero volts; and

section D, comprising the section of the mass-decrease waveform where t is less than t₀ and V is less than zero volts.

Optionally, the mass-increasing waveform comprises a sawtooth voltage waveform comprising alternating linearly increasing voltage and decreasing voltage sections. Optionally, the overall waveform is configured as a periodic waveform that repeats every 720 degrees of rotation of each individual mass change object about the center point, wherein:

an increasing voltage section of the mass-increasing waveform is applied from zero to 180 degrees;

section A is applied from 180 degrees to 270 degrees;

section B is applied from 270 degrees to 360 degrees;

an decreasing voltage section of the mass-increasing waveform is applied from 360 to 540 degrees;

section C is applied from 540 to 630 degrees; and

section D is applied from 630 to 720 degrees;

whereby the net force direction is approximately in the 90 degree direction.

In another aspect of the invention, there is provided a device for producing mechanical power, the device comprising:

at least one mass change object affixed to a moveable frame, the at least one mass change object being configured to undergo an inertial mass change when power having a non-zero time rate of change is applied. thereto;

an accelerator, associated with the at least one mass change object, for accelerating the at least one mass change object along a motion path to an initial speed;

a power source operatively connected to the at least one mass change object and configured to selectively apply to the at least one mass change object (1) a mass-increasing waveform, characterized in that the time rate of change of the power of the mass-increasing waveform is positive, and (2) a mass-decreasing waveform, characterized in that the time rate of change of the power of the mass-decreasing waveform is negative so as to cause the net inertial mass of the at least one mass change object and associated moveable frame to be less than zero;

a regenerative brake, configured to apply a retarding force to the at least one mass change object, so as to recover mechanical power, when said mass-decreasing waveform is applied, and to not apply said retarding force to the at least one mass change object when said mass-increasing waveform is applied;

the power source being configured to apply the mass-increasing waveform to the at least one mass change object when said retarding force is not applied, and to apply the mass-decreasing waveform to the at least one mass change object when the retarding force is applied;

wherein the mass-increasing waveform is a different waveform, as a function of time, than the mass decreasing waveform.

Optionally, he motion path is substantially linear. Optionally, the motion path is substantially circular. Optionally, the regenerative brake includes a connector-disconnector to disconnect the brake from the at least one mass-change object so that no retarding force is applied when a mass-increasing waveform is applied, and to connect the brake to the at least one mass change object so that the retarding force is applied when the mass-decreasing waveform is applied. Optionally, the connector-disconnector is selected from the group consisting of: electromagnetic device, mechanical clutch, hydraulic clutch, pneumatic clutch, a clutch using electrorheological or magnetorheological fluids and a controlled drive system. Optionally, the regenerative brake is selected from the group consisting of: electric motor in regenerative braking mode, electric generator, pneumatic compressor, pneumatic pump, hydraulic compressor and hydraulic pump. Optionally, the time rate of change of the power of the mass-increasing waveform and/or the mass-decreasing waveform is generally linear as a function of time. Optionally, the time rate of change of the power of the mass-increasing waveform and/or the mass-decreasing waveform is generally constant as a function of time. Optionally, the at least one mass change object comprises an electrical device and wherein the power source comprises an electrical power source. Optionally, the at least one mass change object comprises an electrical device selected from the group of capacitor; inductor and transformer. Optionally, the mass change object comprises a capacitor, and wherein the mass-increasing waveform comprises a sawtooth voltage waveform. Optionally, the at least one mass change object comprises a capacitor, and wherein the mass-increasing waveform and the mass-decreasing waveform each comprise a voltage waveform, as a function of time, described by the formula:

V(t)=±(1/C)[C(2t₀−2V₀+2tP₀+(δP/δt)t²)]^{1/2}

wherein t is time, t₀ is an initial time, V₀ is an integration constant representing initial voltage, P₀ is an integration constant representing initial power, C is the capacitance of the capacitor, and δP/δt is the time rate of change of the power of the mass-decreasing waveform.

### BRIEF DESCRIPTION OF THE DRAWINGS

The invention will now be described, by way of example only, with reference to the drawings, which illustrate a preferred embodiment of the invention, and in which:

FIG. 1 shows curves resulting from the application of a sinusoidal AC voltage waveform to a capacitive circuit;

FIG. 2 shows curves resulting from the application of a sawtooth waveform to a capacitive circuit;

FIG. 3 shows curves resulting from the application of a sawtooth waveform to a capacitive circuit where the sharp peaks of the sawtooth waves are approximated as parabolic curves;

FIG. 4 shows a preferred mass-decreasing waveform;

FIG. 5 shows a relationship between power and acceleration;

FIG. 6 schematically shows a linear reactionless thrust device;

FIG. 7 schematically shows a rotary reactionless thrust device;

FIG. 8 is a detailed schematic view of the device of FIG. 7;

FIG. 9 is a block diagram of a system by which variations in operating conditions that may reduce the effectiveness of a reactionless thrust device may be sensed and corrections made;

FIG. 10 shows an example overall input waveform for a rotary reactionless thrust device;

FIG. 11 shows a waveform that may be used for the development of shaft power;

FIG. 12 is a schematic diagram of a capacitor; and

FIG. 13 shows the directions of acceleration of a mass change object in a rotary reactionless thrust system;

FIG. 14 shows a hyperbolic mass increasing waveform with left-right symmetry; and

FIG. 15 shows a hyperbolic mass increasing waveform with up-down symmetry.

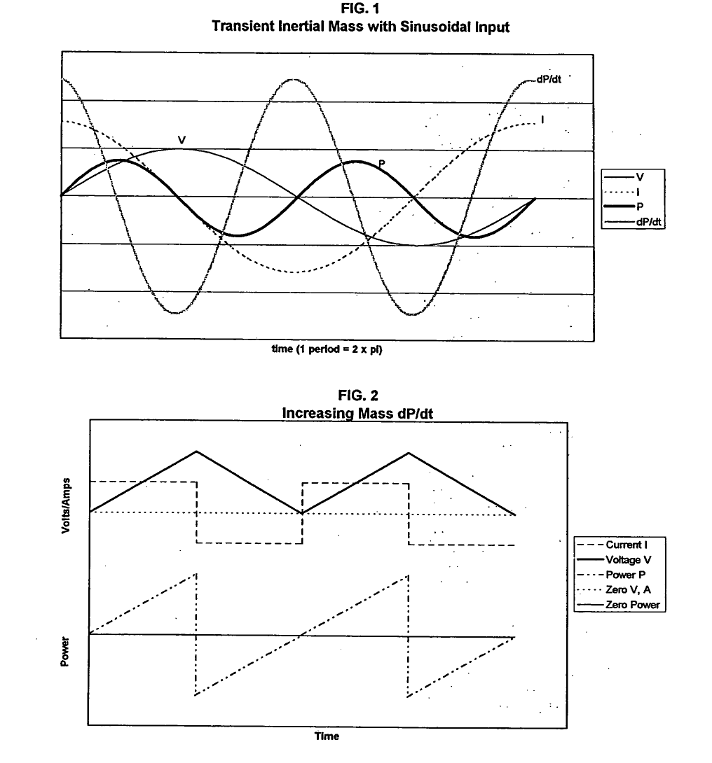

### DETAILED DESCRIPTION OF THE INVENTION

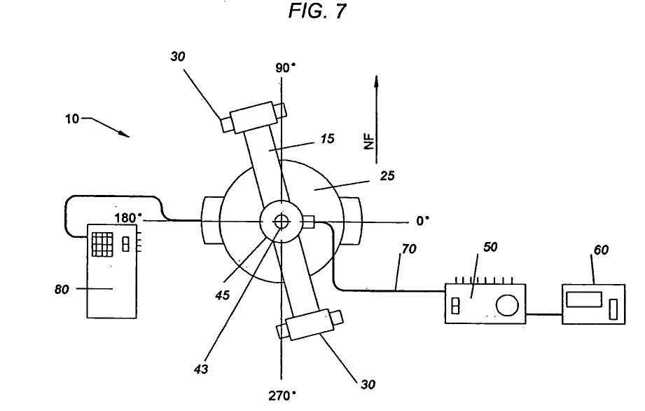

In the attached drawings, like reference characters denote like elements. Referring now to FIGS. 6 and 7, these drawings illustrate two versions of a method and apparatus to generate thrust by varying the inertial mass of a mass change object. The apparatus comprises: a mass change object 30 (e.g. a capacitor, inductor or transformer) preferably having a vacuum core; a waveform generator 60 comprising a means to generate arbitrary waveforms or a device to play back recorded or stored waveforms of the desired shape; an amplifier 50 to increase the voltage of these waveforms to desired levels; an actuator 25 (linear in FIG. 6, rotary in FIG. 7) for accelerating the mass change object 30 and having the capability of generating suitable motion profiles by means of, for example, mechanical cams, electrical servo feedback, hydraulic or pneumatic servo feedback and any necessary control devices 80 associated therewith; a motive power source (not shown) for the linear or rotary actuator 25 (such as electric power, pneumatic or hydraulic fluid supply); connection cables to attach the electrical components including a flexible cable element 70 to allow for the motion of a linear actuator, or a rotary slip ring 45 to permit connection to a rotary actuator; insulators that may be required to contain the terminals and body of the mass change objects; and structural elements 15 to connect the mass change object(s) 30 to the actuator.

In the preferred embodiment, the mass of the mass-change object 30 is changed selectively, such that the changes in mass are used to generate reactionless thrust. Also in the preferred embodiment, a capacitor is used as the mass change object 30. The dielectric medium of the capacitor 30 is preferably a natural or man-made vacuum. For the purposes of this specification, a “vacuum” is a pressure substantially lower than atmospheric pressure. Preferably, the vacuum in the capacitor 30 will be less than 7.6 Torr; 7.6 Torr corresponds to a pressure that is 1% of atmospheric pressure. Most preferably, the vacuum will be approximately 1×10⁻⁷ Torr, or less. Capacitors having a vacuum of 1×10⁻⁷ Torr are commercially available, are manufactured for use in high-power broadcast radio purposes and may have maximum ratings on the order of 100,000 volts.

It will be appreciated that an aspect of the invention comprehends the use, as the mass change object 30, of any electrical component in which a power flux may be induced in a vacuum or near-vacuum core or region within the component. Examples of such components include, but are not limited to, vacuum capacitors, vacuum-core inductors and vacuum-core transformers. Where a natural vacuum exists, such as in space, such an electrical component may be constructed using the present natural vacuum. For example, in such an environment, two conductive plates with a sufficient separation would become a natural vacuum capacitor.

It will further be appreciated that the invention also comprehends the use of non-electrical mass change objects. As δm≈(φ/[4πGρ₀c⁴])(δP/δt), a mass change can be induced in any object having a δP/δt within it. That δP/δt is not necessarily limited to electrical power. For example, a closed-off waveguide may have within its chamber a δP/δt as a result of injected microwaves. Magnetic power may vary with time within a mass change object, as may other types of power, including but not limited to electromagnetic power comprising an emission on the electromagnetic spectrum. The invention comprehends the use of any type of time-varying power. In this specification, the term “time-varying-power object” means an object which may have a change of power with time. It will be appreciated that the invention comprehends the use of any time-varying-power object, having a non-zero time rate of change located at a mass change region 32 associated with the object 30, as the mass change object 30. It will further be appreciated that electrical devices, such as capacitors, inductors and transformers, are preferred time-varying-power objects because it is practical and relatively convenient to deliver time-varying electrical power to them, and because appropriately configured devices of these types are commercially available in useful quantities.

It will be appreciated that the nature of the mass change region, at which the time-varying power is located, will vary according to the type of object 30 used. For example, as described further below, the mass change region 32 in a capacitor comprises the region, between the two plates or conductors 33 that form the capacitor (see FIG. 12). In a coil inductor with a cylindrical coil, the mass change region 32 comprises the space inside the cylinder. In the waveguide mentioned above, the mass change region 32 comprises the space within the closed-off waveguide where the time-varying microwave power is located.

It will be appreciated by those skilled in the art that the relationship between variables such as voltage, current and power are different for different types of electrical devices. Thus for example, in a capacitor, I=CdV/dt, where V is the voltage across the capacitor, t is time, C is the capacitance, and I is the current through the capacitor. By contrast, in an inductor, V=LdI/dt, where V and I represent voltage across and current through the inductor respectively, t is time, and L is the inductance. In general, P=VI, and dP/dt=d(VI)/dt, but this general formula results in specific formulas for power P, and for δP/δt, that are different for each of these devices. Thus, the input voltage or current waveform will take a different form in a capacitor than in an inductor for any particular δP/δt. For similar reasons, the input waveform may be different when other types of electrical devices are used. Finding the appropriate input waveform for a particular electrical device to produce the desired δP/δt could be done by defining the desired δP/δt, and then using the characteristics of the particular electrical device (e.g. I=CdV/dt for capacitors and V=LdI/dt for inductors) to determine the appropriate input waveform.

Similarly, in a time-varying-power object that has varying non-electrical power, the appropriate input, required to produce a δP/δt, can be determined by taking the desired δP/δt, and using the characteristics of the time-varying-power object to determine what input will produce the desired δP/δt. It will be appreciated that, according to the formula δm≈(φ/[4πGρ₀c⁴])(δP/δt), mass change is proportional to δP/δt. Thus, it is possible to produce a mass change having specific characteristics by producing a desired δP/δt selected to result in the specific mass change characteristics desired.

In the preferred embodiment, a commercially available arbitrary waveform generator 60 may be programmed to generate any desired waveform, or in some cases multiple waveforms on multiple channels. Existing means 60 are available off-the-shelf to generate suitable waveforms or play back from storage suitable recorded waveforms of the desired shape. Such existing means include, but are not limited to, an arbitrary waveform generator, a computer or programmable logic controller with suitable digital to analog software and hardware, or an analog storage device such as a tape player. A special purpose device similar to an MP-3 player may be used, but preferably such a device will be designed to closely reproduce the desired waveform and to avoid replication error created by, inter alia, compression algorithms used on such devices. In some embodiments with multiple electrical mass change objects devices 30, it is advantageous to have multiple channels of waveforms operating simultaneously. In some cases, such a generator 60 may be combined with an amplifier 50 to generate sufficiently high-output voltages and currents as required for the particular application.

It will be appreciated that the generator 60 and amplifier 50 of the preferred embodiment, as well as a power supply or other means for supplying energy, function as a power source, connected to the mass change object 30, for producing time varying power having a non-zero time rate of change, preferably including a mass-increasing waveform having a positive time rate of change of power, and a mass-decreasing waveform, having a negative time rate of change of power. It will be appreciated that the invention comprehends the use of other components to serve this function. What is important, in an aspect of the invention, is that the device include a power source, connected to the mass change object 30, for producing time varying power having a non-zero time rate of change, preferably including a mass-increasing waveform having a positive time rate of change of power, and a mass-decreasing waveform having a negative time rate of change of power.

Preferably, the amplifier 50 is capable of faithfully amplifying the waveforms to the necessary voltage, which may exceed 30,000 volts. In some embodiments, multiple channels of amplification may be desired. Such amplification may be accomplished by use of high-voltage tubes, or by use of power resistors and cascade diode networks or other known methods.

The powered actuator 25 may, for example, take the form of a permanent magnet DC motor. Preferably, the actuator 25 has characteristics such that the torque, speed and acceleration appear smooth at the frequencies at or near the waveform frequencies, and where it is possible to rapidly control torque and thus acceleration. In the preferred embodiment shown in FIG. 7, the actuator 25 is a permanent magnet DC motor having a servo feedback capability by means of a commercially available rotary encoder or like device. In general, the actuator 25 may be a linear or rotary or other type of unit, but should be capable of generating suitable programmed motion profiles. The actuator 25 may be, but is not limited to, one of the following: a linear electric motor with servo feedback capability; a linear motion device wherein the motion of a rotary electrical servo motor is converted to linear motion by means such as a belt, chain, cable, lead screw or ball screw; pneumatic or hydraulic linear or rotary motion devices with servo feedback and controller. The motion profiles may be generated by mechanical cams or rod linkages, or electrical servo feedback means with a suitable controller, or by other means. In some cases, it may be possible to generate useful and close approximations of the desired motion without the use of a servo feedback mechanism.

In other cases, it is envisaged that the mass change objects 30 may be connected to the actuator 25 by means of a clutch. When the clutch is engaged, the devices 30 move with the actuator. When it is released, the devices 30 are free to coast, thus reducing their acceleration and disconnecting any inertial effects, created by mass changes in the objects 30, from the actuator 25. Due to the high switching speed which may be required from the clutch in the preferred embodiment, it is anticipated that such a clutch would operate using electromagnetic means. However, other means may be used, which other means include, but are not limited to, a mechanical clutch, a hydraulic or pneumatic clutch, or a clutch using electrorheological or magnetorheological fluids, which fluids have a relatively rapid response time.

The apparatus further preferably includes a control means 80 with the capacity to provide the necessary programmed velocity and acceleration profiles in the selected actuator means (except as noted above). A commercially available servo motor drive system having an integrated controller and drive amplifier that is capable of providing the illustrated motion profiles is suitable. Other control means, including, but not limited to, an electronic controller such as an electric servo drive system with amplifier, a system programmed by cams or similar mechanical means, or an electronic servo drive system with a proportional valve for the control of pneumatic or hydraulic actuators could also be used. In the preferred embodiment, the control means 80 forms part of the accelerator for accelerating the mass change object.

The apparatus further preferably includes a means to provide the necessary electrical, mechanical, pneumatic, hydraulic or other kind of power required by the actuator 25. In the preferred embodiment, this takes the form of an electrical power source (in the case of a DC motor, a regulated DC power supply).

In the case of the preferred rotary actuator 25, a commercially available multi-conductor rotary slip ring 45 may be utilized to transfer the amplified waveforms to the capacitors or other electrical devices acting as mass change objects 30. In the case of a linear actuator 25, a flexible cable element or cable track to provide amplified waveforms to the mass change object(s) 30 as it traverses the range of motion of the actuator 25 is suitable. However, it will be appreciated that other ways of accomplishing the goal of transferring the waveforms to the mass change objects are comprehended. For example, a sufficiently compact and durable waveform generator and amplifier may be developed which can be mounted on the moving components, wherein communication with the actuator controller 80 can be done with wireless means, such as radio or infra-red. In this alternate embodiment, the waveform may be generated external to the moving parts, but the amplifier is preferably placed on the moving components, thus limiting the voltage transferred through the slip ring 45 to low voltages only (typically less than 48 volts).

When electrical mass change objects are used, an insulator may be used to prevent arcing from the terminals or body of the mass change object 30, especially if operated at high voltage where arcing is a concern. Insulation may be accomplished by use of non-conducting materials such as plastics or ceramics. In such high voltage cases, if it is possible to locate the mass change objects 30 away from other conducting components, then insulation may not be required. The operating parameters of the apparatus to generate thrust by inertial mass variance are preferably such that it may be possible to create useful mass change effects with a high-frequency, low-voltage device, thus further reducing the need for insulators.

The apparatus also preferably includes a structural means to mount one or more mass change objects 30 to the actuator 25 in a rigid manner. In the case of a rotary actuator, the structural means preferably takes the form of one or more spokes or arms 15 rigidly connected to the hub 43. In this embodiment, a mass change object 30 is mounted near the end of each arm 15 using, if required, an insulator as described above.

FIG. 7 illustrates a rotary system embodying this principle. Electric motor 25 is controlled by controller 80. Electric motor 25 drives hub 43 to rotate arms 15 onto which are mounted mass change objects 30 in the form of capacitors. Signal generator 60 creates a signal which is amplified by amplifier 50 and fed to the capacitors on arms 15 via lead 70 which utilizes slip ring 45.

FIG. 6 illustrates a linear device by which controlled acceleration effects may be generated synchronized with mass change effects. Low-friction lead screw 12 is driven by servomotor 25 controlled by controller 80. Mass change object 30, taking the form of a capacitor, is mounted to a moving slide 40 with a built-in nut driven by the lead screw 12. The screw 12 thus acts as a track along which the object 30 moves, and also as part of the accelerator that accelerates the object 30 linearly. Programmable signal generator 60 generates a signal which is amplified by amplifier 50 and connected to capacitor 30 by flexible lead 70.

As noted above, inertial mass change is governed by the equation δm≈(φ/[4πGρ₀c⁴])(δP/δt) where φ is the gravitational potential field approximately equal to c² where c is the speed of light. The field is approximated as constant throughout the universe for purposes of calculation. G is the Newtonian gravitational constant. ρ₀ is the density of the mass medium co-located with the time varying power (in the preferred embodiment, the dielectric material of the capacitor). δP/δt is the time rate-of-change of the power applied to the mass change object 30.

In the context of the formula δm≈(φ/[4πGρ₀c⁴])(δP/δt), φ, G and c are universal constants. However, ρ₀ is a property of the time-varying-power object chosen (e.g. capacitor) and may be manipulated. This description will center on capacitors, but parallel principles will apply to other time-varying power objects 30 such as, inter alia, inductors and transformers. In a capacitor, the time-varying power (having non-zero δP/δt) flows through the area of the capacitor where the charge is stored (i.e. the dielectric or the insulating material). The energy in a capacitor is stored as an electric potential between two charged plates separated by an insulator. Thus, the relevant density is not the density of the entire capacitor including the housing, but rather that of the dielectric (i.e. insulator between the plates). Since ρ₀ is in the denominator of the expression for calculating mass change, a smaller value of ρ₀ will give improved results, in the form of a higher-magnitude mass change.

The density of the dielectric material may be regarded as a retarding factor influencing electrically induced inertial mass changes. Woodward chose capacitors with a lightweight, but rigid, dielectric material, and. U.S. Pat. Nos. 6,098,924 and 6,347,766 taught that the capacitors must have a material core. In papers evaluating why his initial expected results were less than expected, he speculated that movement or elastic compression in the dielectric material within the casing of the capacitor might have been affecting the mass change results. Woodward seemed to understand the inertial mass change effect to be taking place within the mass-material contained within the potential field that encompasses the dielectric; therefore, it makes sense that he believed a material core to be necessary. Not only would a material core be necessary on this understanding, but the material of the core must be suitably rigid in order to transmit any forces that arise due to acceleration to the housing of the capacitor and thence to the mechanism.

Therefore, the prior art was based on the understanding that it was necessary for the dielectric to have substantial mass, because the mass change effect was understood as taking place within the mass-material contained within the potential field that encompasses the dielectric. A material core for the capacitor was thus understood to be necessary. However, unexpectedly, it has been discovered that the transient inertial effects may not occur within the mass itself (and may therefore not be dependent on the mass), but within a region of space-time that is coincident with the mass, but otherwise independent of the mass. This arises because of the permissible interchange between mass and energy inherent in the E=mc² of special relativity. The equation F=ma, rewritten in momentum form, rendered in Einsteinian 4-vector format, is:

F=−[(1/ρ₀c)(δE₀/δt),f]

In this equation, E₀ (energy density) has been substituted for the ρ₀ in the time derivative to represent the possibility of an energy flux δE₀/δt (which can be imposed by means of an electric field) and the ρ₀ has been left in the “constant” part of the equation (1/ρ₀c) representing the fixed or “natural” mass of the object, whose related density does not change.

If a capacitor is used which has, instead of a material dielectric insulator, a vacuum, the possible mass change of the capacitor is increased substantially. E₀=ρ₀c² can be used to convert between matter and energy, and it is permissible to replace the physical matter ρ₀ with a small but positive and constant E₀ᵢ, where E₀ᵢ is the energy density resulting from the full matter-to-energy conversion of the matter left in the capacitor's vacuum core when the imperfect vacuum is manufactured. Since E₀ᵢ is a constant, for a given energy flux through the capacitor, there is a tremendous improvement in the change in mass possible with a vacuum core capacitor as compared to a material core. The modified mass change equation, when E₀ᵢ/c² is substituted for ρ₀, becomes the following.

δm≈(φ/(4πG E₀ᵢc²))(δP/δt)

E₀ᵢ is an arbitrarily small value, in the sense that it can be made smaller by improving the vacuum in the capacitor—the better the vacuum, the smaller the E₀ᵢ. E₀ᵢ is in the denominator of the above equation, and therefore, the smaller it is, the larger δm will be. This substitution also results in the c⁴ in the denominator of the previous form of the equation becoming c².

As the mass change effect may well take place in the region of space-time coincident with the time-varying power, the inertial and acceleration forces created are transmitted to the structure of the mass-change object adjacent to the region. Thus, in the case of a capacitor, the power flux is located between the plates. In a case where the capacitor accelerates, between times t₀ and t₁, moving from position p₀ to position p₁, if the distance between p₁ and p₀ is greater than the length of the capacitor, since the capacitor defines the location of both the base energy density E₀ᵢ and the power flux δP/δt which is responsible for the inertial mass change effect δm, the effect moves through that same distance (i.e. the distance p₁ minus p₀). The field where mass change takes place remains captured between the two endplates of the capacitor and is defined by the location of those endplates. Therefore, elasticity in the structure of the endplates would affect how any forces are transmitted to the body of the capacitor. This effect can be minimized, inter alia, by making the structure more rigid.

Therefore, because E₀/c² can be substituted for ρ₀, no actual mass need be used for the mass change effect to take place, or for the equation δm≈(φ/[4πGρ₀c⁴])(δP/δt) to work. An energy presence can be substituted, leading to the conclusion that vast increases in mass change effectiveness can be achieved as ρ₀, the proper mass density, approaches zero.

It will be appreciated that there is no known perfect vacuum, whether man-made or natural (even deep space, a natural vacuum, is not perfect). In particular, any vacuum made by industrial processes will have a remaining detectable mass. The shifting of the very low-pressure gaseous matter as the capacitor accelerates (the atoms will tend to accumulate at the end opposite the direction of acceleration) can affect the transmission of forces to the casing of the capacitor.

An example of this deleterious effect on force transmission is the prior art Woodward device. One peculiar feature of Woodward's device is that the back-and-forth accelerations imposed by the piezoelectric actuator occur within an extremely small distance, described as a few angstroms in the published papers. Thus, in Woodward's device, which has a material dielectric, if there was any elasticity in the dielectric, or a gap between the dielectric and the casing, it is possible that the forces would not have been effectively transmitted to the casing. This is because the movement in each direction before a reversal was so short that it the only effect of the movement might have been compression or shifting of the dielectric by the time force could have begun to be transmitted to the structure of the capacitor, the motion was reversed, causing the dielectric to shift and/or compress in the other direction.

In the preferred embodiment of present invention, this potential difficulty may be overcome in at least one of the following ways. First, the distance moved by the mass change object during each acceleration cycle is a reasonable percentage of the size of the capacitor. The distance moved is preferably at least 5% of the length of the capacitor, and most preferably at least as great as the length of the capacitor. As a result, even after the shifting of the gases left in the vacuum, there would be further motion during which force would be transmitted to the plates and housing of the capacitor, or to the structure of another type of mass change object. Secondly, the apparatus is preferably configured to accelerate in a single direction instead of back and forth, thus minimize the deleterious effect on force transmission by the matter left in the vacuum. The effect of shifting matter is minimized in this configuration because the matter would tend to accumulate at one end of the capacitor and stay there, rather than being shunted from one end to the other. As will be described further below, the rotary device described herein has this benefit, because the mass change object moves in one direction around the hub, rather than reversing direction periodically, as in the linear device.

Electrical devices with non-solid cores, to which time-varying power fluxes can be applied, are commercially available. For example, vacuum capacitors with a vacuum rated at 1×10⁻⁷ torr are commercially available and typically used for high-power broadcast purposes. Also, air core inductors and transformers are commercially available.

The size of the improvement in mass change effectiveness using vacuum mass change regions can be appreciated by comparison with the prior art. One of Woodward's devices used a capacitor with a dielectric material having a density of 3,000 kg/m³. By comparison, a vacuum of 1×10⁻⁷ torr has a density of 1.7×10⁻¹⁰ kg/m³. This represents an improvement in potential mass change of approximately 1.8×10¹³ times.

In addition, it has been found that input waveform shape can be selected to create a desired mass change profile. This has substantial advantages over, inter alia, the Woodward prior art, whose use of resonant circuitry and the attendant requirement for AC waveforms inherently limits it to periodic, reversing mass variations. Given the greatly improved effectiveness associated with using vacuum-core energy storage devices, large mass changes can be derived from relatively small power fluxes. There are specific waveforms will give the best performance depending on whether a mass increase or decrease is required, or other purposes are desired.

It will be appreciated that, a reactionless thrust device Would best operate by accelerating the mass change object differently, depending on the mass of the object at a particular time. In other words, the direction and/or magnitude of the acceleration of the mass change object 30 would be different when the mass of the mass change object 30 has increased than it would when the mass of the mass change object 30 has decreased. The use of a selected acceleration profile in association with a particular mass change profile results in the desired net thrust in a desired direction. Detailed examples of how acceleration and mass change profiles are matched are given below.

It has been found that the matching of acceleration and mass change profiles to produce thrust is facilitated if two distinct input waveforms are used: a mass-increasing waveform (i.e. a waveform that results in a positive δm) and a mass-decreasing waveform (that creates a negative δm) which is a different waveform, as a function of time, than the mass-increasing waveform. This is to be contrasted with Woodward, whose input waveform was not two distinct waveforms, but rather, a single sinusoidal waveform that was always the same as a function of time.

Preferably, the mass-increasing and mass-decreasing waveforms create generally constant mass change effects of the desired type (i.e. constant positive δm or constant negative δm). Such a waveform maximizes mass change effectiveness because the ability to create thrust is related to the magnitude of the mass change, spread over the time that the mass change takes place. Thus, suppose that it is desired to increase the mass of the mass change object between times t₁ and t₂. Because the amount of thrust that can be created generally increases with an increased magnitude of mass change, then, most preferably, the mass change will be generally constant from t₁ to t₂. If the mass change is not constant, then maximum mass change will not be available throughout the time period between t₁ and t₂ to generate thrust, and this is less preferred.

Furthermore, having generally constant mass change simplifies design calculations. If the mass change is constant during any given time period of interest, the second term in the force equation

F=m dv/dt+v dm/dt can be ignored, because dm/dt is zero.

It will be appreciated, however, that the invention comprehends input waveforms that are not constant. Though much less preferred, any mass increasing and mass decreasing waveforms that are different functions of time are comprehended by the invention. Thus, for example, input waveforms that produce linearly varying, but not constant, mass changes can be used, and such waveforms would simplify design calculations as compared to a sinusoidal input, since dm/dt would be constant over the period of the mass change. Nevertheless, what is most preferred is the use of a mass-increasing waveform producing constant, positive mass change and a mass-decreasing waveform producing constant, negative mass change.

In an ideal capacitor, the relationship between voltage and current is I=C(dV/dt) where I equals current through the capacitor, C is the capacitance of the capacitor, and V is the voltage across the capacitor. Using a capacitor as an example mass change object, the preferred mass increasing and mass decreasing waveforms will now be discussed. Since it is desirable to have the mass change be generally constant (and thus, for dP/dt to be generally constant), it will be assumed that the magnitude of dP/dt is a constant K. Thus, for positive mass change, dP/dt=K, and P=P₀+Kt, where P represents power and P₀ is a constant of integration representing an initial power at an initial time. Similarly, for a mass decreasing waveform, dP/dt=−K, and P=P₀−Kt.

To derive the waveform equations, the equation relating voltage to current in a capacitor (I=CdV/dt) and the formula for calculating power in an electrical circuit (P=VI), are used.

The general solution is shown in the following formula.

V(t)=±(I/C)[C(2t₀−2V₀+2tP₀+(δP/δt)t²)]^{1/2}

wherein t is time, t₀ is an initial time, V₀ is an integration constant representing an initial voltage, P₀ is an integration constant representing an initial power, C is the capacitance of the capacitor, and δP/δt is the time rate of change of the power of the mass-decreasing waveform. δP/δt is the desired constant value.

The simplest solution is revealed with positive δP/δt and choosing t₀=0, V₀=0 and P₀=0. This mass-increasing voltage waveform for a capacitor is shown in FIG. 2, and comprises a sawtooth waveform. Because of the ±, the line may be rising or falling. This waveform slopes upward linearly from a base voltage, reaches a peak, and then may slope downward linearly (with the same magnitude of slope as the upward section) until it reaches the base voltage. This cycle can repeat indefinitely. The current I is constant in magnitude but reverses direction periodically, as shown in FIG. 2.

FIG. 2 also shows that the resulting power curve is an upward sloping line with periodic discontinuities. The change in power with time, δP/δt, is equal to the slope of the power line, and is by inspection constant and positive. The power reaches its maximum at the left side of each discontinuity and is at its minimum on the right. Thus, although the power is mathematically undefined at the discontinuity, the drop in power across the discontinuity implies a large negative excursion of δP/δt. Meanwhile, at all points where the power curve is defined, δP/δt is constant and positive.

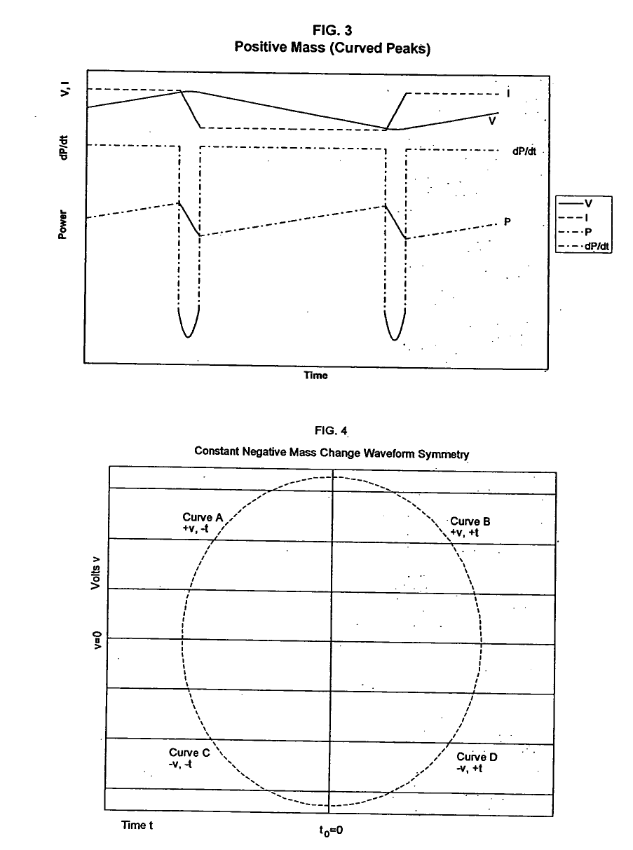

In a man-made system, the driving amplifier would not be able to instantly switch from negative to positive current, as is required to produce the sawtooth voltage input waveform shown in FIG. 2. The practical result is that such a man-made amplifier would produce a small curve at the peak of the voltage. As shown in FIG. 3, where the voltage is taken to drive the system and I=C δv/δt, the voltage peak is modeled as a parabolic curve tangent to the voltage curve, rather than a point as shown in FIG. 2. The result, as shown in FIG. 3, is that there are large negative values to δP/δt (and the concurrent inertial mass change) at the discontinuities. Failure to manage these effects can potentially result in equipment damage, depending on the application. It is also important to note that the total power will sum to zero over time, which can be seen by comparing the positive and negative areas under the δP/δt curve.

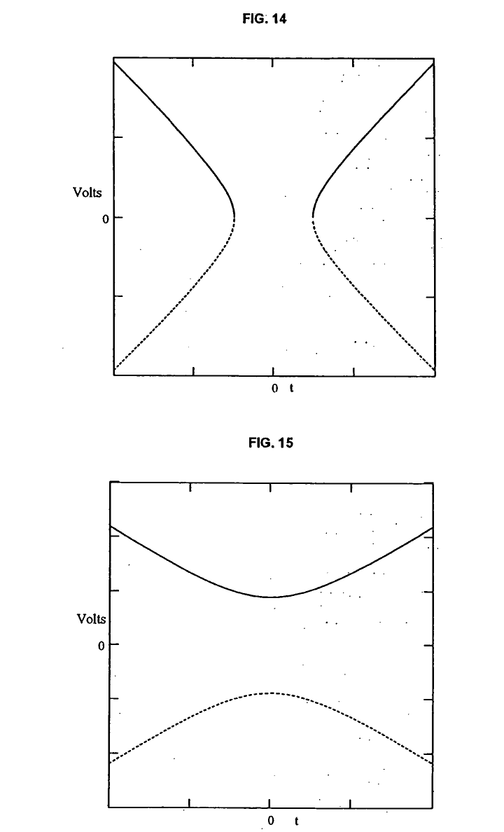

It may also be noted that other initial conditions for positive mass result in hyperbolic curves with up-down and left-right symmetry as shown in FIG. 14 and FIG. 15.

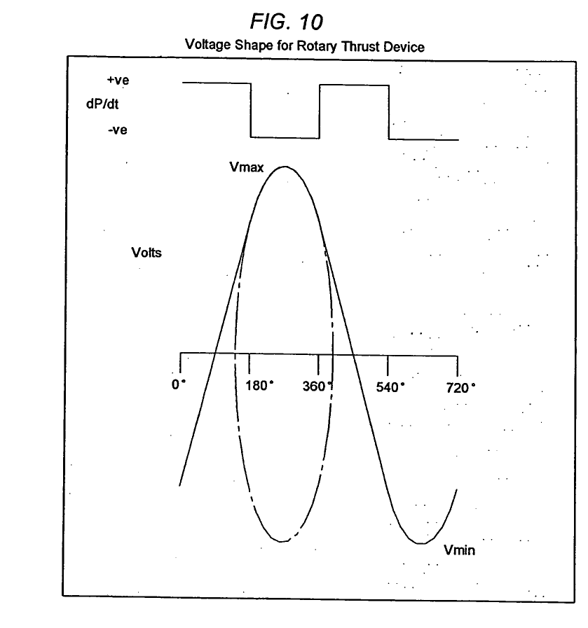

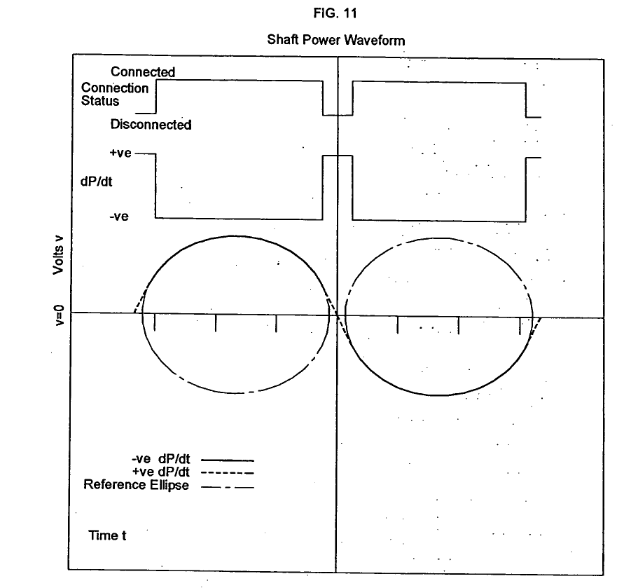

If a negative δP/δt is selected, the curves have a characteristic elliptical shape as shown in FIG. 4 (and as shown in FIGS. 10-11 in dotted outline as reference ellipses). There are two symmetries in the waveforms. Because the time term is squared, the same result holds for time on either side of t₀ (common in a periodic waveform). There is also symmetry about 0 volts.

The hyperbolic and elliptical curves have regions where the tangent to the voltage curve approaches vertical as the curve crosses V=0. These regions may not be used in practice. First, since I=CdV/dt and at the vertical tangent, dV/dt approaches infinity, an infinite current would be required to achieve such a curve. Second, since P=VI, the power at such a location would be equal to zero multiplied by infinity, which value is mathematically undefined.

These factors, along with the ability to set desired initial conditions give rise to the ability to design arbitrary waveforms within certain limits. The limiting amplitude, starting voltage V₀ of a waveform segment, initial power level P₀, initial time t₀ and desired δP/δt can be configured to create the desired waveform segment. Waveform segments may be stitched together to generate a desired effect. In order to avoid undesired δP/δt excursions at discontinuities in the voltage waveforms, the voltage curves can be designed to join and be tangent, so that a smooth continuous δV/δt results.

It will be appreciated that, in the equation δm≈(φ/[4πGρ₀c⁴])(δP/δt), the only two variables within the control of a designer of a reactionless thrust device are ρ₀ and δP/δt. As discussed above, ρ₀ can be controlled, to a substantial extent, by choice and configuration of the mass change object 30. Thus, the preferred embodiment of one aspect of the invention involves the use of a mass change object having a vacuum located at the mass change region 32.

Regarding δP/δt, this variable may theoretically be set at any desired value. Then, using equations, valid for the particular mass change object being used, that relate δP/δt to the variable that drives an input waveform, the specific configuration of that waveform can be determined. In the specific case of the capacitor described about, δP/δt is most preferably set to be a constant, either positive or negative for mass increase or decrease. The equations relating power and voltage are then used to determine the mass-increasing and mass-decreasing input voltage waveforms. As noted, the designer may then configure the initial conditions (e.g. tₒ, Vₒ, Pₒ) to produce the necessary waveforms.

Theoretically, there is no limit on the magnitude of the constant δP/δt that can be chosen by the designer. However, practically, a δP/δt should preferably be chosen which accounts for real-world limitations. Such limitations include the ability for amplifiers or other power sources to faithfully produce and amplify complex waveforms, and the ability of motion equipment associated with the mass change object to switch at high-speed. Other important practical limitations to consider include limitations on the equipment size and waveform frequency imposed by shock wave propagation and sonic effects. Also, structural limitations may exist as a result of shocks to the equipment created by sudden extreme excursions of δP/δt.

It has been found that, in practice, sonic effects limit the maximum frequency that can be used with equipment that is readily available commercially. At reasonable sizes of mechanical equipment (on the order of one metre), this limit is about 100-200 Hz. At 100 Hz, and with a vacuum capacitor rated at 1×10⁻⁷ torr powered by an amplifier with a peak output of 2100 V, a current of ±100 mA and a peak power output of about 21 mW, a theoretical mass change of 325 Kg is generated. In practice, mass changes possible for presently readily available equipment have been found to be practically limited, as higher mass changes have the potential impose damaging structural forces on the capacitor. Changes of 50 Kg or less per capacitor are believed to be practical targets for equipment that is currently available commercially in large quantities, though higher-performance equipment can be made which would allow the practical range of possible mass change to increase.

Preferably, the mass change object 30 will be moved in continuous motion in one direction, due to the effects on force transmission of any remaining matter in the vacuum chamber. In this sense, a linear accelerator for moving the mass change object along a linear path is less preferred, because the size of the linear path is necessarily limited, and motion reversals will be necessary. With each reversal, the matter left in the vacuum will shift to the other end of the mass change region, thus reducing transmission of force to the structure of the mass change object 30. When a linear accelerator is used, it is therefore preferred to complete several input waveform cycles in each direction before reversal to minimize the effect of shifting matter on force transmission.

In determining how to apply mass-changing waveforms to produce a desired mass change profile to create reactionless thrust, it is useful to consider a mass change object (e.g. capacitor) mounted on a small powered carriage on an arbitrarily long track. The capacitor is supplied with the necessary power flux to induce desired mass changes. In this scenario, the goal is to induce the maximum backwards force on the track (i.e. thrust) without exceeding a set velocity V in the carriage, and further, that there should be such a net backward, or reaction, force even after braking the carriage to a stop before the end of the track in accordance with Newton's third law of motion.

In the usual case that we are unable to vary the inertial mass of the carriage, the traction from the powered cart will create a backward force on the track while the carriage is accelerated to velocity V. However, when the carriage is braked back to zero velocity, an equal and opposite amount of momentum will act on the track, resulting in zero net force on the track.

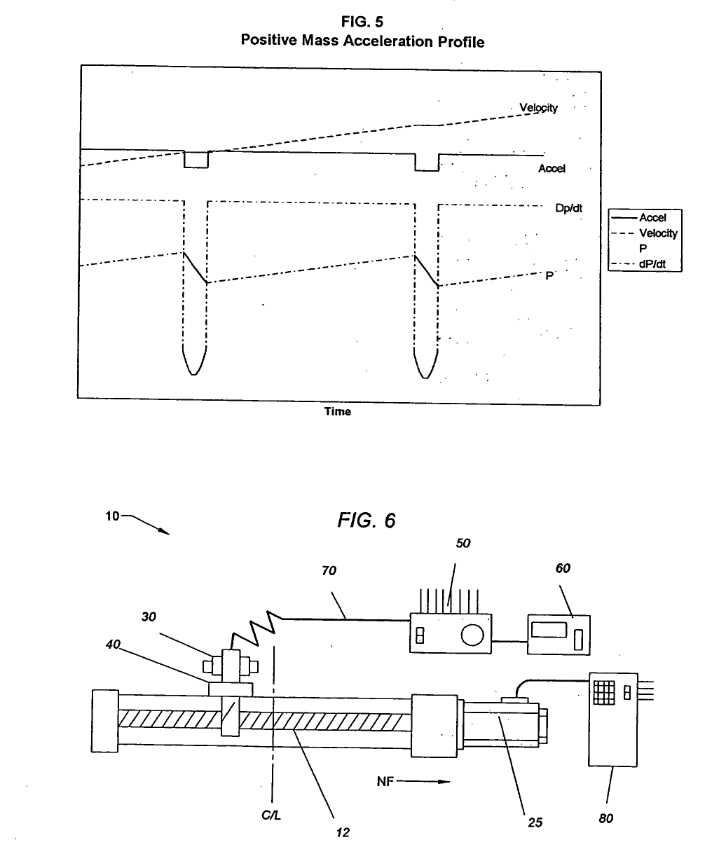

However, if the mass-increasing waveform of FIG. 3 is applied to the capacitor on the powered carriage to produce time-varying power and a corresponding mass increase, it is possible to change this result of zero net force. If the acceleration of the carriage is applied uniformly, the same result of net zero reaction force will occur as the mass changes average out to zero over time, because of the negative excursions of δP/δt. However, if the acceleration of the carriage is turned off during the moments when the mass change is negative, then the track will only see forces due to the higher inertial mass. This is shown in FIG. 5.

If accelerations of the carriage only occur when the carriage is “heavy”, and if the mass change effect is completely turned off during the braking cycle so that braking occurs only at the mass change object's natural mass, then a net backward force on the track is achieved.

One unusual, potential effect of the use of mass-decreasing waveforms is the creation of negative inertia. For example, the powered carriage may have a natural mass of 25 Kg. As mentioned above, a mass change magnitude of 50 Kg may well be practically possible. If a −50 Kg waveform is applied, the net inertial mass of the carriage will be −25 Kg. If the acceleration is controlled so that accelerations are only present during the negative mass cycle, then the system only sees the negative mass, because it is through acceleration that the inertial mass change effect can be exploited. Alternatively, during the positive mass waveform portions, the carriage may be disconnected from the driving means by a clutch means as described herein. In the case of a negative mass, the typical actions in the force equation F=ma are reversed to F=−ma. For example, a braking force applied at the wheels of the carriage (applied only during the negative part of the waveform) would actually accelerate the mass. Here we have the potential to create virtual negative matter, in that while the average mass remains equal to the natural mass, the clutch only permits the associated driving means to sense the mass when it is negative. The described acceleration effect of negative matter is outlined by Dr. Robert Forward in his paper “Negative Matter Propulsion”, J. Propulsion 6, 28-37 (January-February 1990).

A linear, reciprocating, reactionless thrust system is shown in FIG. 6. The mass change object 30 (preferably a capacitor) is mounted on carriage 40, which moves in a back-and-forth motion along lead screw 12, which acts as a track. Waveform generator 60 and amplifier 50 act as a power source to selectively apply the mass-increasing and mass decreasing waveforms to the capacitor. The motor 25 (which is associated with the capacitor) accelerates the capacitor so that it exerts a force on the lead screw 12, the lead screw 12 functioning as a base against which force is exerted. It will be appreciated that the invention comprehends other forms of track and base besides the form of the preferred embodiment.

The following method may be used to generate thrust in the system of FIG. 6. The mass change object 30 begins at one end of lead screw 12. Amplifier 50 is used to generate inertial mass increasing waveforms. The capacitor is accelerated toward the centerline C/L of lead screw 12. The acceleration profile is coordinated so that no acceleration is performed when the waveform reaches a discontinuity with an undesired mass effect (i.e. the negative excursions of δP/δt shown in FIG. 5). Peak velocity will be reached at the centerline. At this time, an inertial mass decreasing waveform is generated. The carriage containing the vacuum capacitor 30 is then decelerated to zero velocity at the other end of the carriage and accelerated back toward the centerline. The acceleration profile is again coordinated so that no acceleration is performed when the waveform reaches a discontinuity with an undesired mass change effect. At this point, once the centerline is again reached, the waveform should be switched to a mass-increasing effect. The carriage should be decelerated to zero velocity at the end and the process can continue as required.

In this embodiment, all accelerations point toward the centerline. If there were no mass changing effects, the result would be alternating, but ultimately self-canceling, forces. However, given that the mass is increased when acceleration occurs in one direction and decreased when in the other direction, a net force occurs. It is expected that the best results will be obtained when the overall movement is larger than the size of the capacitor and when several waveform cycles in one direction are obtained before reversal.

As explained above, it is preferred that the path of the mass change object be as long as possible, so that no motion reversals are required. The use of a trajectory for the mass change object that forms a closed loop eliminates the problem of motion reversals. Using a loop introduces certain design complexities, because the force and acceleration equations for a mass change object that is rotating about a center point include terms representing curl or vorticity. However, it has been found that it is possible to proceed, for practical purposes, by ignoring these terms. The reason is that, for any practical radius, the “linear” effects (e.g. the instantaneous acceleration tangential to the circular path) will dominate any rotational effects.

A reactionless thrust system 10 with a looped path for mass change objects is shown in FIG. 7. The system 10 includes a set of arms 15 on the shaft of a standard electric motor 25 and mount one or more capacitors at the end of the arms 15 as shown in FIG. 7. The arms meet at hub 43 adjacent rotary slip ring 45, which ring is preferably used to deliver the input waveforms to the mass change objects 30. The capacitors 30 thus rotate about hub 43, the hub 43 acting as a center point about which the objects 30 rotate. For illustrative purposes, rotation points of 0 degrees, 90 degrees, 180 degrees and 270 degrees are shown.

As will be explained below, the rotational effects of centripetal force effectively magnify the thrust available. As one capacitor rotates from 0 to 180 degrees, it is applied with an inertial mass increasing waveform (voltage rising). As it moves from 180 through 270 degrees, a mass decreasing waveform (Curve A from FIG. 4) is applied. From 270 degrees to 360 degrees, another mass decreasing waveform (curve B from FIG. 4) is applied. From 360 through 540 degrees, a mass increasing waveform (voltage falling) is applied. From 540 to 630 degrees, a mass decreasing waveform (Curve C from FIG. 4) is applied. From 630 to 720 degrees, another mass decreasing waveform is applied (Curve D from FIG. 4). This 720-degree cycle is then repeated. Thus two revolutions of the capacitor are required for one cycle of the combined mass-increasing and mass-decreasing waveforms. This is illustrated in FIG. 10.

As in any rotating object, the capacitors are accelerated toward the center of rotation at the hub 43. The equal and opposite reaction pulls the hub with a balancing force. Since the capacitor has a greater inertial mass in the sector from 0-180 degrees, a greater force on the hub is generated compared to the sector from 180-360 degrees with a net average thrust in the 90-degree direction.

Thus, it will be appreciated that in both the linear and rotary systems, thrust in the net force direction is created by application of (1) a mass-increasing waveform to the mass change object 30 when the acceleration of the mass change object has at least a component opposite to the net force direction, and (2) a mass-decreasing waveform to the mass change object 30 when the acceleration of the mass change object has at least a component in the net force direction. In the linear device, using FIG. 6 as a guide, suppose that the mass-increasing waveform is applied to the mass change object 30 as it accelerates from the far right side of the track to the centerline. In such a case, the net force direction (i.e. the direction of the net thrust applied against the lead screw 12) will be to the right, as shown by arrow NF in FIG. 6, and as described above.

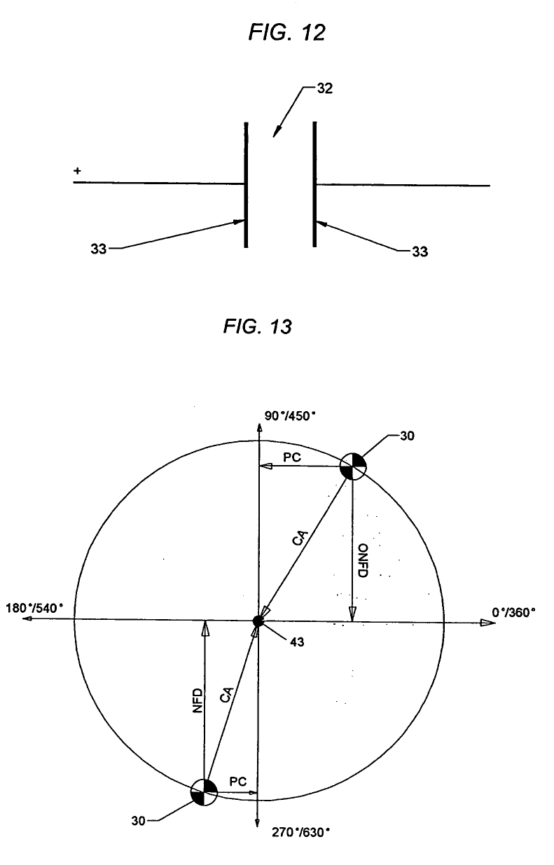

In the rotary device, if the mass change object 30 is rotated around the hub 43 at a constant speed, the mass change object 30 is at all times undergoing a net instantaneous acceleration in the direction of the hub 43. When the waveform combination described above is used, and the net force direction is 90 degrees as shown in FlG. 7, then there is a component of acceleration in the 90 degree direction when the mass change object is between 180 degrees and 360 degrees, and between 540 degrees and 720 degrees. Similarly, there is a component of acceleration opposite to the net force direction when the mass change object is in the 0-180 degree range and in the 360-540 degree range. This is illustrated in FIG. 13.

In FIG. 13, a mass change object 30 is shown in the range 0-90-180 degrees, or 360-450-540 degrees. In this range, the centripetal acceleration (CA) vector is the sum of two perpendicular components. One of these components is a perpendicular component (PC) to the net force direction. The other is a component opposite to the net force direction (ONFD). Thus, in this range, the mass change object has an acceleration component opposite to the net force direction, and in this range, mass increasing waveforms are applied. In FIG. 13, a mass change object in the range 180-270-360 degrees or 540-630-720 degrees is also shown. The object in this range has a centripetal acceleration (CA) that is the sum of two perpendicular vector components. One (PC) is perpendicular to the net force direction, and the other (NFD) is in the net force direction. Thus, in this range, the mass change object has an acceleration component in the net force direction, and in this range, mass decreasing waveforms are applied. It will be appreciated that the overall input waveform, that is, the combination of mass-increasing and mass-decreasing waveforms, is configured so that the average mass change over time is zero. This is required for any practical system in which the magnitude of power does not increase indefinitely.

Additional capacitors (or, in other embodiments, other objects 30) may be added around the mass change object rotary trajectory with input waveforms in appropriate phase being applied to each object 30 according to its position on the trajectory, as described above. The more objects 30 are present, the smoother the thrust will be. A less effective, and thus less preferred, device may be constructed using only a mass-increasing or decreasing effect in one mass change object only. It will also be appreciated that the net thrust direction may be steered by varying the phase of the waveform relative to the rotation.

It has been found that if a ±5 Kg mass changer is induced in two capacitors at only 12 Hz, and corresponding rotation of 720 rpm at a radius of 0.25 m, a net thrust on the order of 9,000 N can be generated (comparable to one of the engines on a small business jet). This effect may be scaled by: increasing the frequency and rpm; increasing the arm radius; increasing the mass change; or increasing the number of capacitors.

Preferably, a smooth transition from mass increasing to mass decreasing waveforms with be generated, as any sudden δP/δt reversals like those shown in FIG. 5 would interfere with the thrust generation and have the potential for damaging the capacitor or other object 30.

In a linear, reciprocating, reactionless thrust system as shown in FIG. 6, the acceleration may be stopped whenever an undesirable δP/δt excursion occurs, so that the device does not see this effect. This can be accomplished because there is, practically, only one acceleration taking place, and it is oriented along the track. However there are two accelerations to consider with rotary machinery. The first is the tangential acceleration caused by speeding up or slowing down the motor. This may be controlled as desired. However centripetal acceleration, the acceleration of rotating masses toward the center of rotation, is proportional to the square of rotational velocity. Thus, as long as the capacitors (or other objects 30) are moving along their rotational path, they will be accelerated, even when δP/δt excursions take place, and even if their speed is constant. As described below, for a rotary device, input waveforms are preferably applied in a manner that substantially avoids discontinuities, and thus sudden δP/δt spikes. However, real-world waveforms are not perfect, and some spiking may take place. Therefore, care must then be taken to generate waveforms with controlled shaped peaks so that the magnitude of sudden is known and, when combined with the rotational speed, is within the structural capacity of the machine and capacitors to resist. Elastic mounting means, able to move and absorb shock in the radial direction, but substantially rigid in the tangential direction, may be designed to cushion these forces.

As explained above, large excursions of δP/δt take place, inter alia, at discontinuities in the input waveform. In the linear system of FIG. 6, these discontinuities can be dealt with by using a connector-disconnector, optionally in the form of a clutch. When the clutch is engaged (i.e. connecting the mass change object 30 to the accelerator), the mass change object 30 moves in response to the accelerator. When it is disengaged, the mass change object 30 is disconnected from the accelerator, and the mass change object is substantially unaccelerated—i.e. it coasts. By disengaging the clutch during discontinuities that produce undesirable excursions of δP/δt from the desired constant value, it is possible to prevent these excursions from having a practical effect on the creation of thrust by isolating the mass change object from the base against which it exerts a force.

However, in a rotary device, the mass change object is always accelerating when in motion, if only toward the hub. Therefore, preferably, the combination of mass-increasing and mass-decreasing waveforms that forms the overall input waveforms is configured to reduce or eliminate discontinuities that create unwanted excursions of δP/δt. Such an overall waveform is shown in FIG. 10. As previously described above, the overall waveform, which repeats every two rotations or 720 degrees, comprises a combination of mass-increasing and mass-decreasing waveforms selected to create a net thrust in a selected direction. As can be seen in FIG. 10, these mass-increasing and mass-decreasing waveforms are arranged so as to have no discontinuities between them. In other words at the point where one waveform section meets another, the slope of the tangent of each section is the same as that of the other section. The result, in this preferred embodiment, is the elimination of unwanted excursions of δP/δt associated with discontinuities in the overall input waveform.

A reactionless thrust device such as those described above may possibly also be configured to generate shaft power. Such a system may have a physical configuration as shown in FIG. 7, having, for example, two mass change objects 30, preferably capacitors, moving along a substantially circular motion path. Means have been described above wherein the illustrated device may be used for the generation of thrust. In general, the motion of a mass change object in a rotary system has two components, namely angular motion and radial. The system, at any given time, has an angular velocity representing the rotation rate, and angular acceleration will increase or decrease the rotation rate. Radial accelerations are imposed on the mass change objects 30 by the rigid arms 15, in the form of centripetal acceleration corresponding to centripetal forces. The centripetal forces are proportional to the square of the instantaneous tangential velocity of the mass change objects 30. Preferably, in a rotary thrust system as described above, there is a constant rotation rate for a given desired thrust level. In a system with two mass change objects 30, one method of developing thrust is to provide one mass change object with a mass-increasing waveform while the opposite mass change object is provided with a mass-decreasing waveform, in accordance with the principles outlined above. For example, both waveforms may take the form of FIG. 10, but be shifted in phase by 180° relative to each other.

By contrast, in a system configured for shaft power, all mass change objects 30 will be provided with the same waveform. In the case where mass change objects 30 are capacitors, the voltage waveform will preferably take a form where they are predominantly negative mass waveforms, as illustrated in FIG. 11. where for the majority of a given cycle a mass decreasing effect is applied to each capacitor such that the value is strongly negative. In this case, the not moment of inertia for the entire rotational structure may become temporarily negative (i.e. the rotor of DC motor 25, hub 43, mounting arms 15 and capacitors 30). Considering the angular motion and the principles of negative matter described above, a braking torque applied to the shaft by a regenerative brake, configured to apply a retarding force to the shaft, thus extracting shaft power, would cause the assembly to accelerate and the rate of rotation to increase. Since the waveform power is bounded, there must be a corresponding interval of positive δP/δt. Therefore, when the δP/δt goes positive, it would be necessary to disconnect the mass change objects 30 from the regenerative brake so that the regenerative brake does not apply the retarding force to the mass change objects 30 during positive δP/δt. (If it did, the net result would be that the regenerative brake sees only the average value—namely, the natural mass of the mass change object(s).) The connector-disconnector used to connect the brake to the object(s) 30 when the mass-decreasing waveform is applied, and to disconnect the brake from the object(s) 30 when the mass-increasing waveform is applied may optionally comprise: turning off current to a permanent magnet DC motor (current is proportional to torque; no torque, no acceleration—thus, the motor acts as the connector-disconnector); using a servo drive controller to maintain constant rotational velocity during that interval; or using an electrical or mechanical, hydraulic or pneumatic clutch, or a clutch using rapid response electrorheological or magnetorheological fluids to disconnect the assembly from the shaft at the necessary time. Since the braking during negative inertial mass is expected to cause angular acceleration, the rate of rotation may increase to unsafe or undesired levels. If the accelerating rotary assembly exceeded a desired rotary speed, the negative mass effect could be turned off and the system slowed as necessary.

It is also necessary to consider the radial acceleration or centripetal force effects. Since all of the mass change objects 30 are provided with the same waveform, and assuming the presence of two or more such objects 30 as illustrated in FIG. 7, then the centripetal forces would cancel and there is no net force in the net force direction NF. However, the centripetal forces will impose structural loads on the device on the order of hundreds of gravities at typical spin rates. The device must be strong enough to withstand the loads imposed and the δP/δt values should preferably not be permitted to approach theoretically infinite values. It will also be appreciated, as a consequence of the balanced centripetal forces that while in a device where net force is to be generated, the phase of the waveforms must be synchronized with the rotation position, no such synchronization is required for operation of a device configured for shaft power.

It may be useful to summarize and compare the conditions whereby a rotary device such as shown in FIG. 7 may be used for shaft power versus thrust. In a shaft power application, the rotation rate will be variable, the same waveform is provided to all mass change objects, no synchronization of the waveform with rotation is required, and a connector-disconnector is needed.

For thrust applications the rotation rate is preferably constant, phase shifted waveforms are provided to each mass change object, which waveforms are synchronized with the absolute position of the rotation, the rotation rate is preferably constant and no connector-disconnector is required.

Although an electrical motor used in regenerative braking mode is the preferred method of extracting shaft power from such a device, the invention comprehends any suitable method of extracting power, including, but not limited to an electric generator, pneumatic compressor, pneumatic pump, hydraulic compressor and hydraulic pump.

It will also be appreciated that power may be extracted in an equivalent linear device. In one example of such a linear device, the mass change object may be accelerated and braked in a substantially linear motion path using a linear induction motor. Like rotary motors, a linear induction motors may function as a regenerative brake and recover power from the application of retarding forces. As described above, if the retarding forces are applied during a period when the net inertial mass of the moving structure containing a mass change object is negative, then the moving structure and mass change object will accelerate. One disadvantage of such a linear device is that in the absence of a closed path, reciprocating motion is required. Other modes of extracting power in a linear fashion are also comprehended by the invention, including, but not limited to pneumatic and hydraulic devices.

As electrical properties change with temperature and other conditions in circuits, the effect of a given input waveform may change. Therefore, it would be advantageous to monitor the effects of such changes and induce compensating changes in the input waveforms using a feedback monitoring system as illustrated in FIG. 9. A current (i) sensor 61 and a voltage (V) sensor 62 can be employed and the output from these sensors connected to a multiplier 63 that calculates the instantaneous power (P=VxI). Note that the power flux δP/δt is the critical variable. The output of the multiplier can then be fed into a comparator 64 that compares the actual power with the expected value at a particular point in the cycle. A waveform compensator 65 can then be devised to correct the waveform to achieve the desired result. A modified waveform is then generated by the generator 60 and output to the circuit. Such a device can be developed using discrete components or by means of software within a computer processor device with suitable analog-to-digital and digital-to-analog hardware added.

In the description of the invention given herein, more and less preferred waveforms have been described. It will be appreciated that the invention comprehends the use of approximations of such waveforms to achieve mass change that approximates the mass change obtained from using the waveforms described herein. It will be appreciated that, sometimes, due to equipment limitations or other practical limitations, approximations of desired input waveforms will be easier to use, and may provide adequate results.

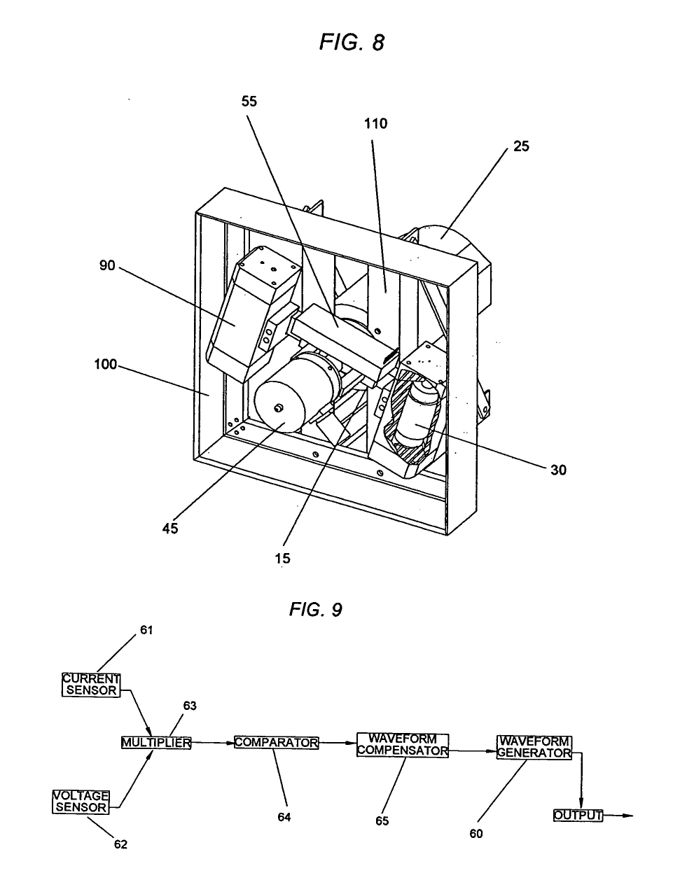

Experiments were conducted using a device essentially the same as shown in FIG. 7. The structure of the experimental unit is shown in FIG. 8. A difference from the configuration shown in FIG. 7 is that a compact amplifier was used and affixed to the rotating arms. Supply power for the amplifier and the waveform signal (provided by a digital waveform generator) was routed to the rotating arms though a multi-conductor rotary slip ring. In addition, due to the high voltages used, a plastic housing was manufactured to prevent arcing from the capacitors to the nearby metal frame.

The motor used was a 1 hp permanent magnet DC unit. Such motors have the characteristic that the voltage is proportional to the speed of the motor, and the input current is proportional to torque. A digital signal generator was used to create a saw-tooth waveform with a low voltage of 0 V and a high voltage of 5V. After amplification the resulting waveform had a minimum voltage of 18,000 volts, a peak voltage of 25,000 volts and a frequency of 6 Hz. The amplifier had the least distortion in this voltage range.

The capacitors used were commercially available Jennings vacuum capacitors with a capacitance of 12 pF at up to 35,000 V, with a vacuum of 1×10⁻⁷ torr.

The first experiment began with the motor in a stopped condition. The waveform generator was initiated and the amplifier powered up. Then power was routed to the motor. A programmable logic controller (PLC) with an analog to digital converter (AND) was used to drive the motor through a high-speed solid-state relay. The A/D converter sensed the input voltage from the waveform generator. When the voltage reached a predetermined level, the motor was cut off for 20 mS. This ensured that the current to the motor cut off during the peak of the waveform, and that the motor coasted (or experienced no angular acceleration) during this peak and the associated δP/δt reversal. The time of 20 mS was used as the particular relay in the experimental setup had an activation delay of up to 10 mS. FIG. 5 illustrates this method.

In order to establish a control where the inertial mass variation effect was disabled, the power to the amplifier was cut off for some control runs. Because the digital signal generation was still enabled, this could be used to provide identical waveforms to the A/D of the PLC for motor on/off pulse control. Thus the only difference in the two experimental conditions was whether a high power flux (δP/δt) was present in the capacitors.

Thus it was expected that if the inertial mass of the capacitors was increased with the high power flux (δP/δt), then the fixed available torque in the motor at a given voltage setting should show an increased rotary acceleration during runs without the high power flux in effect.

The current in the motor was also monitored to ensure that it was the same during both experiments.

A visual target was affixed to one of the rotating arms and the experiments were recorded with a video camera. The tape was then examined frame by frame and records made of the number of frames required for each rotation during the acceleration. Since each frame represents 1/30^{th} of a second, precise measurements could be made.

Experiments were run at a number of voltages between 25-35 volts. In one test grouping summarized below, 8 tests were performed in 4 pairs (one with inertial modification on, one with the effect turned off). The elapsed time for 4 full revolutions was compared between the two conditions in each test pair.

| | |
|---|---|
| Average difference: | .13 Sec |
| Minimum difference: | .10 Sec |
| Maximum difference: | .17 Sec |

It is believed that the variations in time measured were caused in part by the measurement technique which used discrete 1/30^{th} second measurement snapshots. For example, the device may have traveled 4.0 rotations in one snapshot and 4.1 in the nearest comparable snapshot on a different run. Note however that there was a difference of 0.10 Sec or more in all test pairs.

In another test under the same conditions, data for 7 revolutions was extracted. The torque capacity of the motor was used to calculate the inertial mass change that would result in the acceleration change. This calculation was performed at each revolution.

| | |
|---|---|
| Average Calculated Mass Difference: | .43 Kg |
| Minimum Calculated Mass Difference: | .27 Kg |
| Maximum Calculated Mass Difference: | .65 Kg |

It is believed that the variations in mass difference were caused by the measurement technique which used discrete 1/30^{th} second measurement snapshots. For example, the device may have traveled 4.0 rotations in one snapshot and 4.1 in the nearest comparable snapshot on a different rotation.

A further experiment was performed to determine the sensitivity of the system to mass changes. The high voltage amplifier was turned off. A voltage regulator was used to set the system to a minimum stalling condition. The voltage was then increased by the minimum amount possible to begin rotation. The power to the motor was then turned off, and then on again to ensure that rotation would occur. The voltage amplifier was then turned on to create the mass increase effect. It was found in all tests that the motor would stall with the amplifier turned on (creating the increased inertial mass increase effect).

A calibration was then performed to determine the minimum sensitivity of the test setup. Weights were added to rotary arms to increase the inertial mass of the system to mimic the effects. Since the weights could not be added at the capacitor location, the position of each weight was measured so that the equivalent change in moment of inertia could be assigned as if the weight were located at the same radius as the capacitors.

Weights totaling an equivalent mass change (at the capacitor radius) of 0.18 Kg were added before there was no more room. The motor was capable of turning this increased mass without stalling. Since the capacitor system with the amplified mass increasing waveform was capable of stalling the motor, it was concluded that the inertial mass change of the capacitors was greater than 0.18 Kg.

This experiment verified two theories. The first is that a vacuum component would be significantly more efficacious in generating the desired mass change effect than a capacitor with a material core. The second is that a low-frequency shaped waveform would be effective in creating a large and almost continuous mass change when combined with a pulsed drive wherein the drive was not accelerated when the mass change effect was not of the desired type.

Measured values showed that the mass change was greater than 0.18 Kg. Calculated values based on the measured acceleration times and motor characteristics showed that the mass change was 0.43 Kg within a range of +0.21 Kg and −0.16 Kg.

How does this compare to the theoretical value of inertial mass change? The value measured is less than the theoretical calculated value of 7.3 Kg by a factor of about 16. Several theories must be considered as to the reason for this discrepancy. First, it must be noted that the estimated value of φ depends on our knowledge of the size and matter distribution in the universe. Other factors relate to the equipment. For example, the amplifier was not able to faithfully replicate the input signal at the high voltage. It is expected that future experiments with improved equipment will be able to more closely approach theoretical values. Nevertheless, the results achieved point to industrial scale inertial mass changes (on the order of 1 lb) that have immediate potential for useful application.

Since numerous modifications and changes will readily occur to those skilled in the art, the invention is not limited to the exact preferred construction and operation shown and described, and accordingly, all suitable modifications and equivalents may be resorted to, falling within the scope of the invention.

The embodiments of the invention in which an exclusive property or privilege is claimed are defined as follows:

1. An object for inducing an inertial mass change therein, the object comprising a mass change region configured to have time-varying-power, having a non-zero time rate of change, located thereat, wherein a vacuum is located at said region.

2. An object as claimed in claim 1, wherein the object comprises an electrical device, and wherein said time-varying power comprises electrical power.

3. An object as claimed in claim 2, wherein the object is selected from the group comprising capacitor, inductor and transformer, and wherein said region comprises a vacuum core.

4. An object as claimed in claim 1, wherein said power is magnetic in nature.

5. An object as claimed in claim 1, wherein said power comprises power of electromagnetic radiation.

6. An object as claimed in claim 5, wherein said object comprises a waveguide.

7. An object as claimed in claim 6, wherein said power comprises microwave power.

8. A device for inducing inertial mass change in an object, the device comprising:
a mass change object comprising an object as claimed in claim 1;
a power source configured to produce time-varying power having a non-zero time rate of change, the source and the mass change object being configured to locate said time-varying power at the mass change region of the mass change object to change the inertial mass of the mass change object.

9. A device for inducing inertial mass changes in an object as claimed in claim 8, wherein the device further comprises an accelerator to accelerate the mass change object while the time-varying power is located at said mass change region.

10. A device for inducing inertial mass change in an object, the device comprising:
a mass change object comprising an object as claimed in claim 3;
a power source configured to produce time-varying power having a non-zero time rate of change, the source and the mass change object being configured to locate said time-varying power in the mass change region of the mass change object to change the inertial mass of the mass change object.

11. A device for inducing inertial mass change in an object as claimed in claim 9, wherein the accelerator comprises a linear accelerator for accelerating the mass change object along a linear path.

12. A device for inducing inertial mass change in an object as claimed in claim 9, wherein the accelerator comprises a rotary accelerator for rotary acceleration of the mass change object.

13. A device for inducing inertial mass change in an object as claimed in claim 12, wherein the accelerator comprises, an electric motor having servo feedback capability to produce a motion, in accordance with a predetermined motion profile, for said mass change object.

14. A device for inducing inertial mass change in an object as claimed in claim 11, wherein the accelerator comprises an electric motor having servo feedback capability to produce a motion, in accordance with a predetermined motion profile, for said mass change object.

15. A device for inducing inertial mass change in an object as claimed in claim 11, wherein the device further comprises a connector-disconnector, configured to selectively connect and disconnect the mass change object and the accelerator, such that substantially zero force is transmitted between the mass change object and the accelerator during disconnection, and said mass change object is accelerated by the accelerator during connection.

16. A device for inducing inertial mass change in an object as claimed in claim 12, wherein device further comprises a connector-disconnector, configured to selectively connect and disconnect the mass change object and the accelerator, such that substantially zero force is transmitted between the mass change object and the accelerator during disconnection, and said mass change object is accelerated by the accelerator during connection.

17. A device as claimed in claim 8, wherein the power source comprises a generator of waveforms and an amplifier to amplify said waveforms to selected levels.

18. A device as claimed in claim 8, wherein the power source comprises a source of stored waveforms, and an amplifier to amplify said waveforms to selected levels.

19. A device for producing a net force against a base, in a net force direction, the device comprising:
at least one mass change object associated with the base, the at least one mass change object being configured to undergo an inertial mass change when power having a non-zero time rate of change is applied thereto;
an accelerator, associated with the at least one mass change object, for accelerating the at least one mass change object such that the at least one mass change object exerts a force against the base;.
a power source operatively connected to the at least one mass change object and configured to selectively apply to the at least one mass change object (1) a mass-increasing waveform, characterized in that the time rate of change of the power of the mass-increasing-waveform is positive, and (2) a mass-decreasing waveform, characterized in that the time rate of change of the power of the mass-decreasing waveform is negative;
the power source being configured to apply the mass-increasing waveform to the each at least one mass change object when the acceleration of that mass change object has at least a component opposite to the net force direction, and to apply the mass-decreasing waveform to the each at least one mass change object when the acceleration of that mass change object has at least a component in the net force direction;
wherein the mass-increasing waveform is a different waveform, as a function of time, than the mass decreasing waveform.

20. A device as claimed in claim 19, wherein the time rate of change of the power of the mass-increasing waveform is generally linear as a function of time.

21. A device as claimed in claim 19, wherein the time rate of change of the power of the mass-increasing waveform is generally constant as a function of time.

22. A device as claimed in claim 19, wherein the time rate of change of the power of the mass-decreasing waveform is generally linear as a function of time.

23. A device as claimed in claim 19, wherein the time rate of change of the power of the mass-decreasing waveform is generally constant as a function of time.

24. A device as claimed in claim 19, wherein the at least one mass change object comprises an electrical device and wherein the power source comprises an electrical power source.

25. A device as claimed in claim 24, wherein the at least one mass change object comprises an electrical device selected from the group of capacitor, inductor and transformer.

26. A device as claimed in claim 19, wherein the mass change object comprises a capacitor, and wherein the mass-increasing waveform comprises a sawtooth voltage waveform.

27. A device as claimed in claim 19, wherein the at least one mass change object comprises a capacitor, and wherein the mass-increasing waveform and the mass-decreasing waveform each comprise a voltage waveform, as a function of time, described by the formula:
V(t)=±(1/C)[C(2t₀−2V₀+2tP₀+(δP/δt)t²)]^{1/2}
wherein t is time, t₀ is an initial time, V₀ is an integration constant representing initial voltage, P₀ is an integration constant representing initial power, C is the capacitance of the capacitor, and δP/δt is the time rate of change of the power of the mass-decreasing waveform.

28. A device as claimed in claim 19, wherein the accelerator comprises a reciprocating accelerator configured to accelerate the at least one mass change object along a substantially linear path, and wherein the accelerator and power source are configured such that that the at least one mass change object is substantially unaccelerated during discontinuities in or between the mass-increasing and mass decreasing waveforms.

29. A device as claimed in claim 19, wherein the accelerator comprises a rotary accelerator having at least one arm carrying the at least one mass change object in a substantially circular path about a center point, and wherein the accelerator and power supply are configured to apply the mass-increasing and mass decreasing waveforms such that the average mass change over time is substantially zero.

30. A device as claimed in claim 19, wherein the accelerator comprises an actuator for moving the at least one mass change object and a controller for controlling the actuator.

31. A device as claimed in claim 29, wherein the power source is configured to apply said mass-increasing and mass-decreasing waveforms in an overall waveform, wherein the overall Waveform is substantially free of discontinuities (1) within the mass-increasing waveforms, (2) within the mass-decreasing waveforms, and (3) between mass-increasing and mass-decreasing waveforms.

32. A device as claimed in claim 31, wherein the mass decrease waveform is generally elliptical and comprises four sections, the four sections comprising:
section A, comprising the section of the mass-decrease waveform where t is less than t₀ and V is greater than zero volts;
section B, comprising the section of the mass decrease waveform where t is greater than t₀ and V is greater than zero volts;
section C, comprising the section of the mass-decrease waveform where t is greater than t₀ and V is less than zero volts; and
section D, comprising the section of the mass-decrease waveform where t is less than t₀ and V is less than zero volts.

33. A device as claimed in claim 32, wherein the mass-increasing waveform comprises a sawtooth voltage waveform comprising alternating linearly increasing voltage and decreasing voltage sections.

34. A device as claimed in claim 33, wherein the overall waveform is configured as a periodic waveform that repeats every 720 degrees of rotation of each individual mass change object about the center point, wherein:
an increasing voltage section of the mass-increasing waveform is applied from zero to 180 degrees;
section A is applied from 180 degrees to 270 degrees;
section B is applied from 270 degrees to 360 degrees;
an decreasing voltage section of the mass-increasing waveform is applied from 360 to 540 degrees;
section C is applied from 540 to 630 degrees; and
section D is applied from 630 to 720 degrees;
whereby the net force direction is approximately in the 90 degree direction.

35. A device for producing mechanical power, the device comprising:
at least one mass change object affixed to a moveable frame, the at least one mass change object being configured to undergo an inertial mass change when power having a non-zero time rate of change is applied thereto;
an accelerator, associated with the at least one mass change object, for accelerating the at least one mass change object along a motion path to an initial speed;
a power source operatively connected to the at least one mass change object and configured to selectively apply to the at least one mass change object (1) a mass-increasing waveform, characterized in that the time rate of change of the power of the mass-increasing waveform is positive, and (2) a mass-decreasing waveform, characterized in that the time rate of change of the power of the mass-decreasing waveform is negative so as to cause the net inertial mass of the at least one mass change object and associated moveable frame to be less than zero;
a regenerative brake,configured to apply a retarding force to the at least one mass change object, so as to recover mechanical power, when said mass-decreasing waveform is applied, and to not apply said retarding force to the at least one mass change object when said mass-increasing waveform is applied;
the power source being configured to apply the mass-increasing waveform to the at least one mass change object when said retarding force is not applied, and to apply the mass-decreasing waveform to the at least one mass change object when the retarding force is applied;
wherein the mass-increasing waveform is a different waveform, as a function of time, than the mass decreasing waveform.

36. A device as claimed in claim 35, wherein the motion path is substantially linear.

37. A device as claimed in claim 35, wherein the motion path is substantially circular.

38. A device as claimed in claim 35, wherein the regenerative brake includes a connector-disconnector to disconnect the brake from the at least one mass-change object so that no retarding force is applied when a mass-increasing waveform is applied, and to connect the brake to the at least one mass change object so that the retarding force is applied when the mass-decreasing waveform is applied.

39. A device as claimed in claim 38, wherein the connector-disconnector is selected from the group consisting of: electromagnetic device, mechanical clutch, hydraulic clutch, pneumatic clutch, a clutch using electrorheological or magnetorheological fluids and a controlled drive system.

40. A device as claimed in claim 35, wherein the regenerative brake is selected from the group consisting of: electric motor in regenerative braking mode, electric generator, pneumatic compressor, pneumatic pump, hydraulic compressor and hydraulic pump.

41. A device as claimed in claim 35, wherein the time rate of change of the power of the mass-increasing waveform is generally linear as a function of time.

42. A device as claimed in claim 35, wherein the time rate of change of the power of the mass-increasing waveform is generally constant as a function of time.

43. A device as claimed in claim 35, wherein the time rate of change of the power of the mass-decreasing waveform is generally linear as a function of time.

44. A device as claimed in claim 35, wherein the time rate of change of the power of the mass-decreasing waveform is generally constant as a function of time.

45. A device as claimed in claim 35, wherein the at least one mass change object comprises an electrical device and wherein the power source comprises an electrical power source.

46. A device as claimed in claim 45, wherein the at least one mass change object comprises an electrical device selected from the group of capacitor, inductor and transformer.

47. A device as claimed in claim 35, wherein the mass change object comprises a capacitor, and wherein the mass-increasing waveform comprises a sawtooth voltage waveform.

48. A device as claimed in claim 35, wherein the at least one mass change object comprises a capacitor, and wherein the mass-increasing waveform and the mass-decreasing waveform each comprise a voltage waveform, as a function of time, described by the formula:
V(t)=±(1/C)[C(2t₀−2V₀+2tP₀+(δP/δt)t²)]^{1/2}
wherein t is time, t₀ is an initial time, V₀ is an integration constant representing initial voltage, P₀ is an integration constant representing initial power, C is the capacitance of the capacitor, and δP/δt is the time rate of change of the power of the mass-decreasing waveform.
